(19) United States
(12) Patent Application Publication
(10) Pub. No.: US 2025/0384381 A1
(43) Pub. Date: Dec. 18, 2025

(54) STORING AND RETRIEVING SENSOR DATA WITH A BLOCKCHAIN

(71) Applicant: Teknor Apex Company, Pawtucket, RI (US)

(72) Inventors: Fabricio Arteaga, Sugar Land, TX (US); Michael Roberts, Providence, RI (US); Yundong Wang, Lancaster, MA (US)

(21) Appl. No.: 19/237,485

(22) Filed: Jun. 13, 2025

Related U.S. Application Data
(60) Provisional application No. 63/660,167, filed on Jun. 14, 2024.

(51) Int. Cl. G06Q 10/0639; G06Q 10/0637; G06Q 50/04

(52) U.S. Cl. CPC G06Q 10/06393; G06Q 10/0637; G06Q 50/04; G06Q 2220/00

(57) ABSTRACT

Among other things, data characterizing a manufacturing process is received. An amount and species of volatile organic compounds (VOCs) released during manufacturing is determined based on the data characterizing the manufacturing process. The data characterizing the amount and species of VOCs released during the manufacturing process is provided.

### CROSS-REFERENCE TO RELATED APPLICATIONS

This application claims the benefit of priority to U.S. Provisional Patent Application No. 63/660,167, filed on Jun. 14, 2024, and titled “STORING AND RETRIEVING SENSOR DATA WITH A BLOCKCHAIN”, the entire contents of which are hereby incorporated by reference herein.

### TECHNICAL FIELD

The subject matter described herein relates to data storage along a supply chain with a distributed system.

### BACKGROUND

During manufacturing of various products, pollutants are produced. Such pollutants can include tainted water, air particulates, carbon, volatile organic compounds (VOCs), and noise. With climate change becoming a more discussed topic, consumers are actively looking for ways to reduce their environmental impact and will often look for and purchase “greener” products when they are available.

### SUMMARY

This disclosure relates to storing and retrieving sensor data with a blockchain.

An example implementation of the subject matter described herein is a method with the following features. Data characterizing a manufacturing process is received. An amount and species of volatile organic compounds (VOCs) released during manufacturing is determined based on the data characterizing the manufacturing process. The data characterizing the amount and species of VOCs released during the manufacturing process is provided.

Aspects of the example method, which can be combined with the example method alone or in combination with other aspects, can include the following. The data characterizing the manufacturing process includes data received from a sensor characterizing species and types of VOCs detected during a manufacturing process. The data characterizing the manufacturing process includes data characterizing lot numbers corresponding to timestamps corresponding to the manufacturing process.

Aspects of the example method, which can be combined with the example method alone or in combination with other aspects, can include the following. The data characterizing the manufacturing process includes a proportion of each lot directed to a subsequent manufacturer.

Aspects of the example method, which can be combined with the example method alone or in combination with other aspects, can include the following. Providing the data characterizing the amount and species of VOCs released during the manufacturing process includes the following. A chemical fingerprint is determined based on the data characterizing the amount and species of VOCs released during the manufacturing. the chemical fingerprint is stored on a blockchain.

Aspects of the example method, which can be combined with the example method alone or in combination with other aspects, can include the following. Providing the data characterizing the amount and species of VOCs released during the manufacturing process includes displaying the amount and species of VOCs released during the manufacturing process on a consumer device.

Aspects of the example method, which can be combined with the example method alone or in combination with other aspects, can include the following. Operating parameters of a manufacturing device are adjusted based on the determined amount and species of volatile organic compounds (VOCs) released during manufacturing.

An example implementation of the subject matter described herein is a system with the following features. A sensor is coupled to a manufacturing device. The sensor is configured to sense an amount and species of volatile organic compounds (VOCs) produced by the manufacturing device. The sensor is configured to produce a signal indicative of the amount and species of the VOCs produced. A controller is coupled to the manufacturing device and the sensor. The controller is configured to control the manufacturing device responsive to the signal. A cloud-based storage system is coupled to the controller. The cloud-based storage system is configured to receive data characterizing a manufacturing process from the controller. The data characterizes the manufacturing process including data characterizing the signal.

Aspects of the example system, which can be combined with the example system alone or in combination with other aspects, can include the following. The cloud-based storage system includes functionality for storing data on a blockchain.

Aspects of the example system, which can be combined with the example system alone or in combination with other aspects, can include the following. The cloud-based storage system includes functionality for generating a cryptographically secure portion of data. The cryptographically secure portion of data includes the data characterizing the manufacturing process.

Aspects of the example system, which can be combined with the example system alone or in combination with other aspects, can include the following. The data characterizing the manufacturing process includes data received from a sensor characterizing species and types of VOCs detected during a manufacturing process and data characterizing lot numbers corresponding to timestamps corresponding to the manufacturing process.

Aspects of the example system, which can be combined with the example system alone or in combination with other aspects, can include the following. The data characterizing the manufacturing process includes a proportion of each lot directed to a subsequent manufacturer.

An example implementation of the subject matter described herein is a method with the following features. A blockchain storing data characterizing a manufacturing process is queried. The data characterizing a manufacturing process responsive to querying the blockchain is received. An amount and species of volatile organic compounds (VOCs) released during manufacturing of a consumer or industrial product is determined based on the data characterizing the manufacturing process. The data characterizing the amount and species of VOCs released during the manufacturing process is provided.

Aspects of the example method, which can be combined with the example method alone or in combination with other aspects, can include the following. The data characterizing the manufacturing process includes data received from a sensor characterizing species and types of VOCs detected during a manufacturing process and data characterizing lot numbers corresponding to timestamps corresponding to the manufacturing process.

Aspects of the example method, which can be combined with the example method alone or in combination with other aspects, can include the following. The data characterizing the manufacturing process includes a proportion of each lot directed to a subsequent manufacturer.

Aspects of the example method, which can be combined with the example method alone or in combination with other aspects, can include the following. A consumer device receives data characterizing a barcode of the consumer or industrial product. Querying occurs in response to receiving the data characterizing the barcode.

Aspects of the example method, which can be combined with the example method alone or in combination with other aspects, can include the following. The product is a garment.

Aspects of the example method, which can be combined with the example method alone or in combination with other aspects, can include the following. Providing includes displaying the amount of VOCs produced during the manufacture of the consumer or industrial product.

Aspects of the example method, which can be combined with the example method alone or in combination with other aspects, can include the following. Determining amount and species of volatile organic compounds (VOCs) released during manufacturing of the consumer or industrial product is done by a consumer device.

Aspects of the example method, which can be combined with the example method alone or in combination with other aspects, can include the following. The consumer device is a mobile phone or tablet.

Aspects of the example method, which can be combined with the example method alone or in combination with other aspects, can include the following. Determining amount and species of volatile organic compounds (VOCs) released during manufacturing of the consumer or industrial product is done by a cloud-based system.

Aspects of the example method, which can be combined with the example method alone or in combination with other aspects, can include the following. The species of the VOCs include a chemical composition from at least one of the following chemical groups: alkyl hydrocarbons, aromatic amines, amines, alkyl aldehydes, aldehydes, alkyl phenols, salicylate esters, aromatic ethers, bisphenols, phthalates, benzothiazoles, organometallics, parabens, azodyes, aceto/benzophenones, chlorinate paraffins, per-and polyfluoroalkyl substances (PFAs), halogenated hydrocarbons, aromatic hydrocarbons, ketones, alcohols, carboxylic acids, lactones, unsaturated aldehydes, and/or unsaturated ketones.

### BRIEF DESCRIPTION OF THE FIGURES

These and other features will be more readily understood from the following detailed description taken in conjunction with the accompanying drawings.

FIG. 1 is a flowchart of a method that can be used with aspects of this disclosure;

FIG. 2 is a block diagram of an example supply chain that can be monitored by the subject matter described herein;

FIG. 3 is a schematic diagram of a single manufacturing device and a consumer application;

FIG. 4A is a schematic diagram of a dryer that can be used as a manufacturing device;

FIG. 4B is a schematic diagram of a blender that can be used as a manufacturing device;

FIG. 4C is a schematic diagram of a twin screw extruder that can be used as a manufacturing device;

FIG. 4D is a schematic diagram of a single screw extruder that can be used as a manufacturing device;

FIG. 4E is a schematic diagram of an injection molding system that can be used as a manufacturing device;

FIG. 4F is a schematic diagram of manufacturing facility that can be used with aspects of this disclosure; and

FIG. 5 is a block diagram of a computer system that can be used with aspects of this disclosure.

### DETAILED DESCRIPTION

As consumers seek to better understand the environmental impact of their purchases, there is a need to provide accurate tracking of a product through the entire manufacturing process and supply chain. The subject matter within this disclosure allows for such tracking. Pollutants, such as volatile organic compounds (VOCs), generated during the production of manufactured products are measured. Those measurements recorded on distributed computer system, such as a blockchain, in order to later evaluate the amount of pollutants released in the manufacture of a specific item. In use, a system uses sensors to determine VOC emissions at each stage of a manufacturing process by associating detected VOC emissions with lot numbers or something similar at each stage of production and tracking the distribution of each lot to the next manufacturing process. For products that are manufactured continuously rather than in batches, polymer and compounding materials are typically packaged into bags, boxes, bulk trucks, or railcars. In some implementations, a number of these packaging units or certain quantity of materials in volume or weight may be grouped together and assigned one lot number or batch number with a certificate of analysis (COA) showing the average properties of the materials for the assigned lot or batch. In this way, a lot number or batch number for each bulk truck or railcar can be assigned. VOC emissions measured by the sensor or the average of multiple measurements representing the materials in the packaging unit or groups of packaging units can be added to the COA and stored digitally through a blockchain system. In some implementations, post blending is done to homogenize the properties of the materials before they are packaged into the bag, box/gaylord, bulk truck or railcar. The certificate of analysis goes with the material to the next manufacturer in the supply chain, where the COA data is used as the properties of the incoming raw material for the specified lot or batch. The system stores all of the collected data (including VOC amounts, species, lot numbers, etc.) in the blockchain (or similar cloud/distributed system). The blockchain can then be accessed and read at a later time to determine a total amount of emissions associated with the consumer or industrial product.

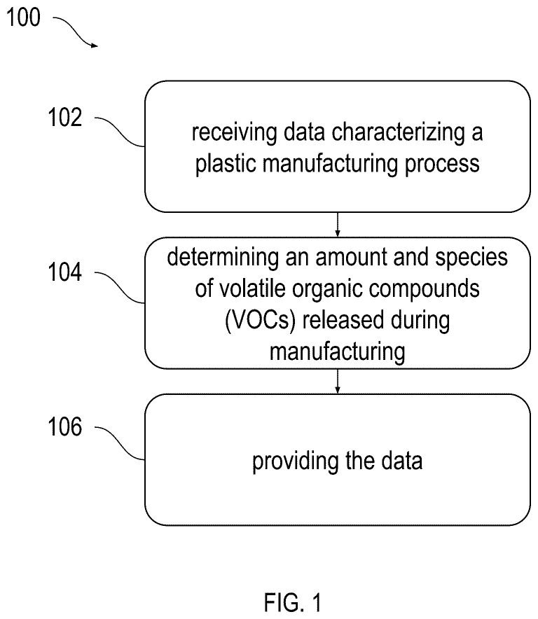

FIG. 1 is a flowchart of a method 100 that can be used with aspects of this disclosure. At 102, data characterizing a manufacturing process is received. More specifically, the data is received by a cloud or other distributed computing storage system, such as a block chain.

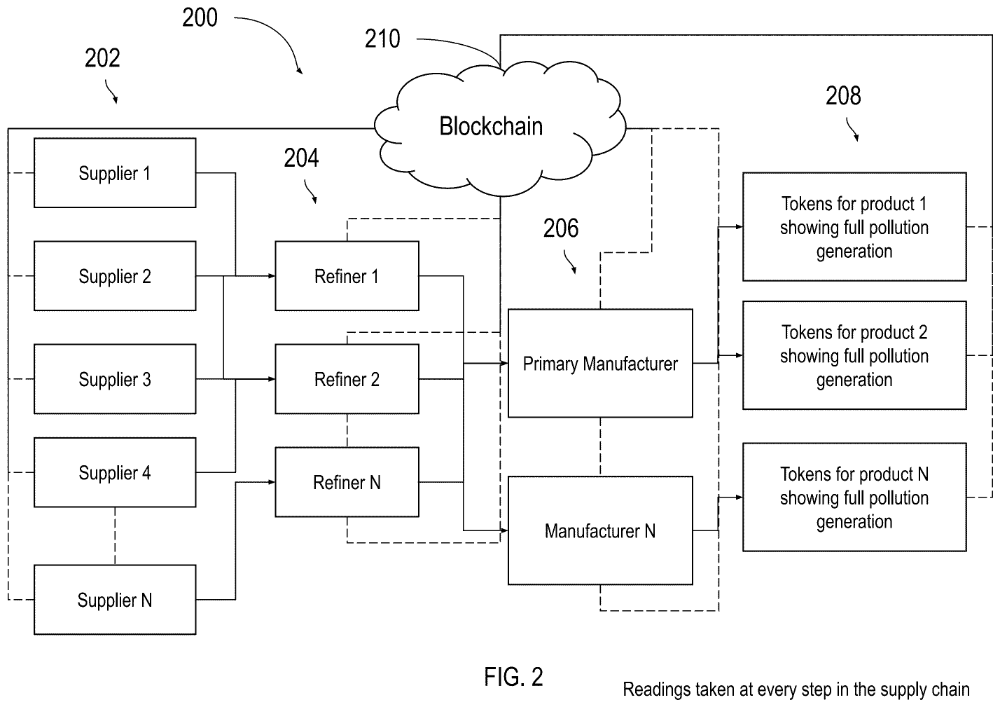

Focusing more on the manufacturing process, FIG. 2 is a block diagram of an example supply chain 200 for consumer or industrial products that can be monitored by the subject matter described herein. For the sake of simplicity, the supply chain is divided into four main categories: suppliers 202, refiners 204, manufacturers 206, and retailers 208. These terms are merely meant as terms used to group various stages of the supply chain 200 and should not be interpreted by their strictest definition. Similarly, while described in substantially four steps of manufacturing, greater or fewer manufacturing steps can be used without departing from this disclosure. While primarily being described as a consumer or industrial product supply chain, the subject matter described herein is applicable to other supply and/or manufacturing chains as well.

At the beginning of the supply chain 200 are the suppliers 202. These groups process, harvest, or otherwise collect raw materials, for example, crude oil, natural gas, wood, or, wool, etc. In some instances, the suppliers can also condition the raw materials. For example, a supplier can split crude oil into various chemicals to be used in manufacturing processes. During the collecting and/or conditioning process, various data, for example, from sensors and/or programable logic controllers (PLCs) is collected and uploaded to a distributed, or cloud computing system. In some implementations, the cloud-based storage system includes functionality for generating a cryptographically secure portion of data. The cryptographically secure portion of data includes the data characterizing the manufacturing process. Such a cloud based system can include, for example as a blockchain 210. Such data characterizes aspects of the collecting and/or conditioning process, such as what type and what kind of VOCs and pollutants are emitted during such processes. Such data can be associated with a specific batch, or lot, of raw and/or conditioned products produced.

The suppliers 202 can provide their collected or conditioned materials to various refiners 204. These refiners 204 further process the collected and/or conditioned materials to produce refined materials. For example, a refiner may include formulators or compounders who melt blend polymer or plastic powder or pellets with additives to make the final plastic pellets for the downstream manufacturers. For example, plastic pellets can be extruded into filaments or threads. The various lots produced by the suppliers 202 are tracked to the refiners. In instances where a lot is split to go to different refiners 204, data regarding the batch or lot can be split, for example, by mass or volume, such that the data associated with the lot is proportionally divided between the portions of the split lot. Data characterizing the refining process at each refiner 204, collected, for example, from PLCs and or sensors, is collected and uploaded to the blockchain. The data can be associated with various lots of the refined materials.

The refiners 204 can then provide their refined materials to various primary manufacturers 206. The primary manufacturers 206 turn the various refined materials into consumer or industrial products to be sold at retailers. The primary manufacturers may receive multiple refined or raw materials to construct the consumer or industrial products. For example, the primary manufacturer can receive textiles and thread to produce a garment. In instances where a lot from a refiner 204 is split to go to different primary manufacturers 206, data regarding the batch or lot can be split, for example, by mass or volume, such that the data associated with the lot is proportionally divided between the portions of the split lot. Data characterizing the refining process at each manufacturer 206, collected, for example, from PLCs and or sensors, is collected and uploaded to the blockchain. The data can be associated with various lots of the consumer or industrial products.

The consumer or industrial products are then shipped from the primary manufacturers 206 to retailers 208 where consumers can purchase the consumer or industrial products. In some instances, the retailers may have sensors that take various measurements within the retail environment. In such instances, these measurements can be a part of data characterizing the retail environment, and such data can be uploaded to the blockchain. For each product purchasable by a consumer, a digital token can be generated. The digital token can be used to look up data, for example pollutants, that were produced at each stage of the supply chain, including data collected from the suppliers, refiners, manufacturers, and retailers. Such pollution can include VOCs or other pollutants. Alternatively or in addition, other environmental impacts can be determined, such as how much water was consumed by the supply chain to produce the product.

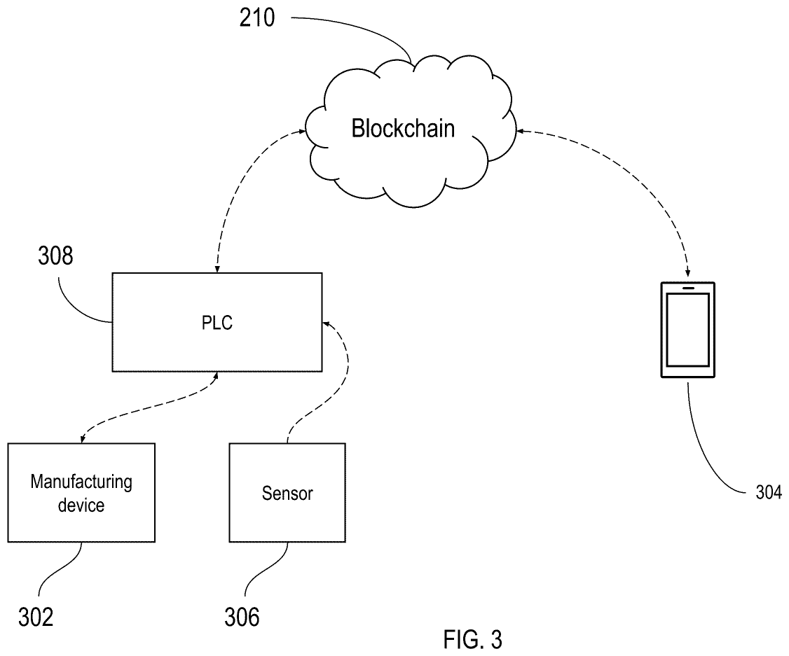

FIG. 3 is a schematic diagram of a single manufacturing device 302 and a consumer device 304. The manufacturing device can be located at a supplier 202, refiner 204, or primary manufacturer 206. The manufacturing device 302 can include or be associated with a sensor 306. In some implementations, this sensor is configured to detect various pollutants. For example, in some implementations, an amount and species of volatile organic compounds (VOCs) produced by the manufacturing device. In such an implementation, the sensor is configured to produce a signal indicative of the amount and species of the VOCs produced.

A controller, such as a PLC 308, is coupled to the manufacturing device 302 and the sensor 306. The PLC 308 is configured to control the manufacturing device 302 and receives data from the manufacturing device 302. For example, the PLC 308 may send a signal to the manufacturing device 302 to perform an operation at a target parameter, and the manufacturing device sends a signal indicative of the actual parameter. In some embodiments, the PLC can adjust the manufacturing device responsive to or based on the signal received from the sensor 306.

The PLC 308 is then coupled to a cloud-based storage system, such as the blockchain 210. As previously discussed, the blockchain is configured to receive data characterizing the manufacturing process from the PLC 308. Within the supply chain 200, multiple PLCs 308 from multiple suppliers 202, refiners 204, primary manufacturers 206, and, in some implementations, retailers 208, provide data to the blockchain. In some implementations, a PLC can be coupled to multiple devices simultaneously.

Based on the data captured by the PLC 308, an amount and type of pollutants produced during operation of the manufacturing device can be determined. Referring back to FIG. 1, in some implementations, at 104, an amount and species of volatile organic compounds (VOCs) released during manufacturing can be determined based on the data characterizing the manufacturing process. In such implementations, data characterizing the amount and species of VOCs released during the manufacturing process is uploaded to the blockchain 210 from the PLC 308. In some implementations, a chemical fingerprint is determined based on the data characterizing the amount and species of VOCs released during the manufacturing. The chemical fingerprint includes data characterizing a composition and amount of the various VOCs released during manufacturing. In such implementations, data characterizing the chemical fingerprint can be uploaded and stored on the blockchain 210.

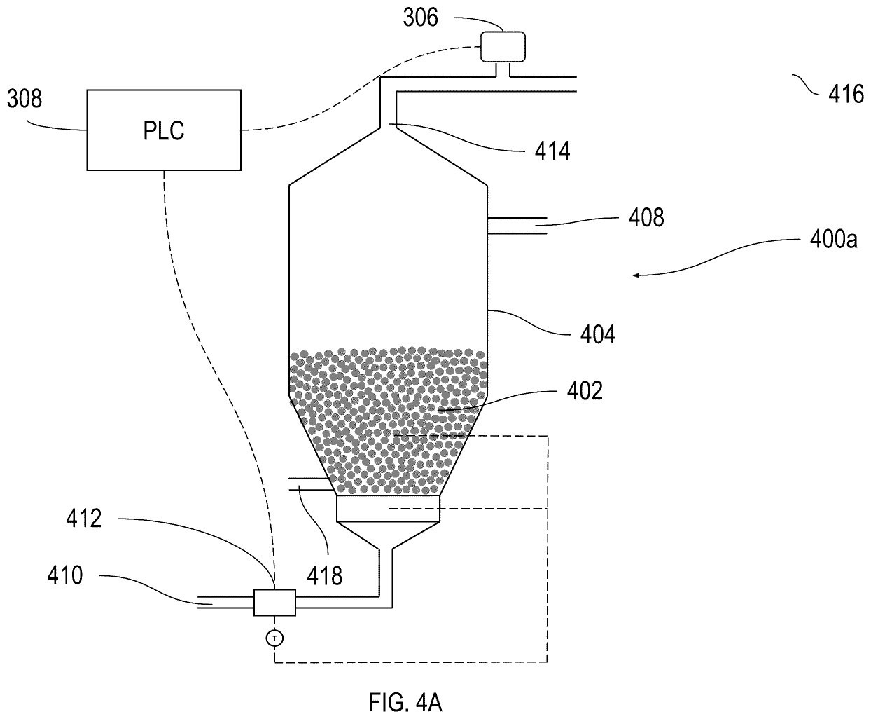

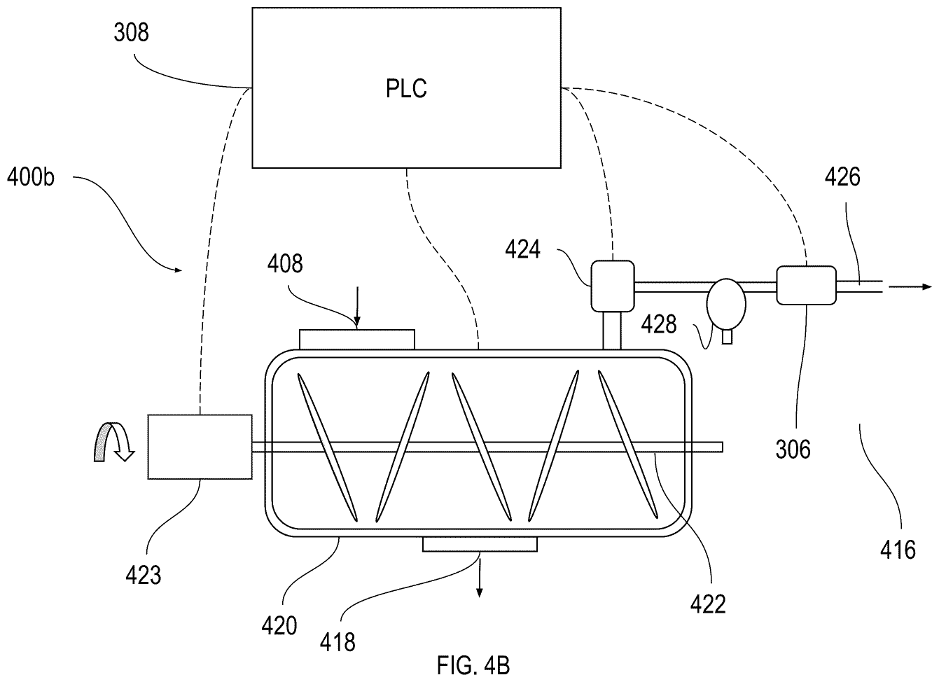

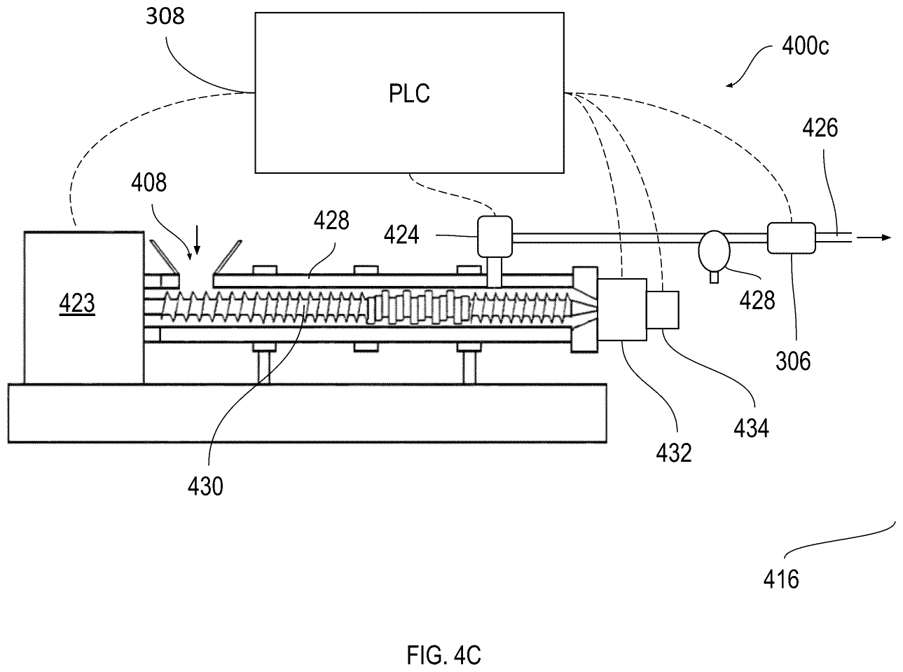

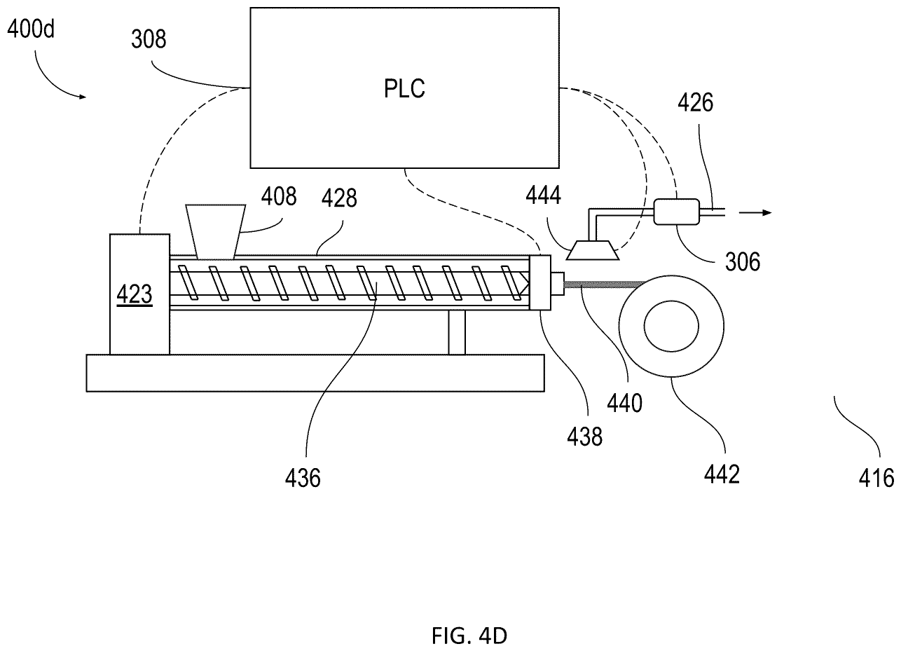

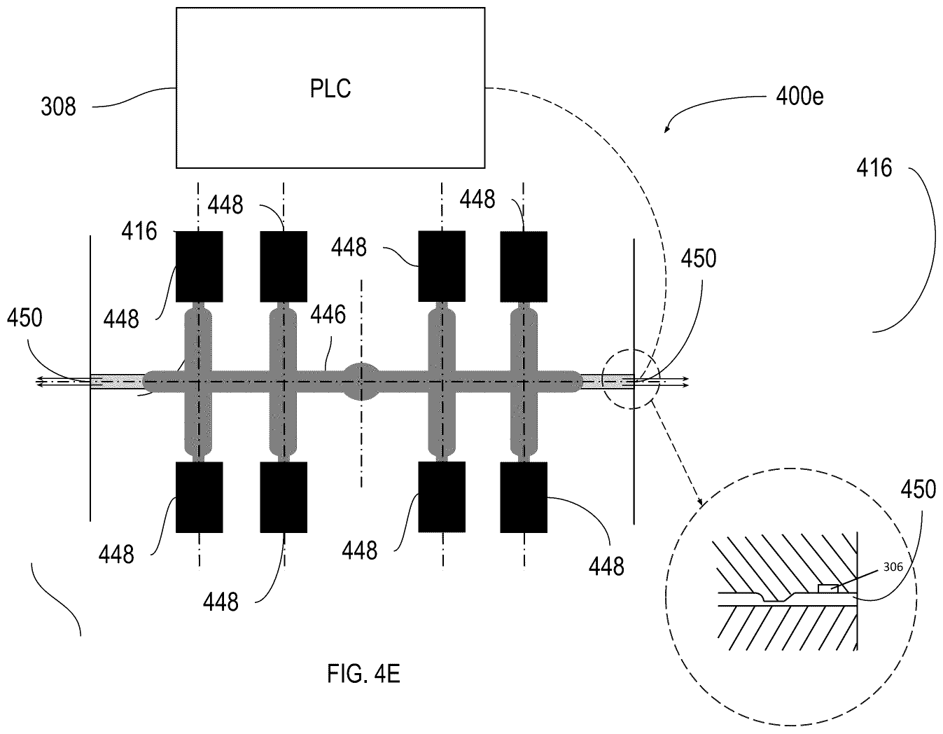

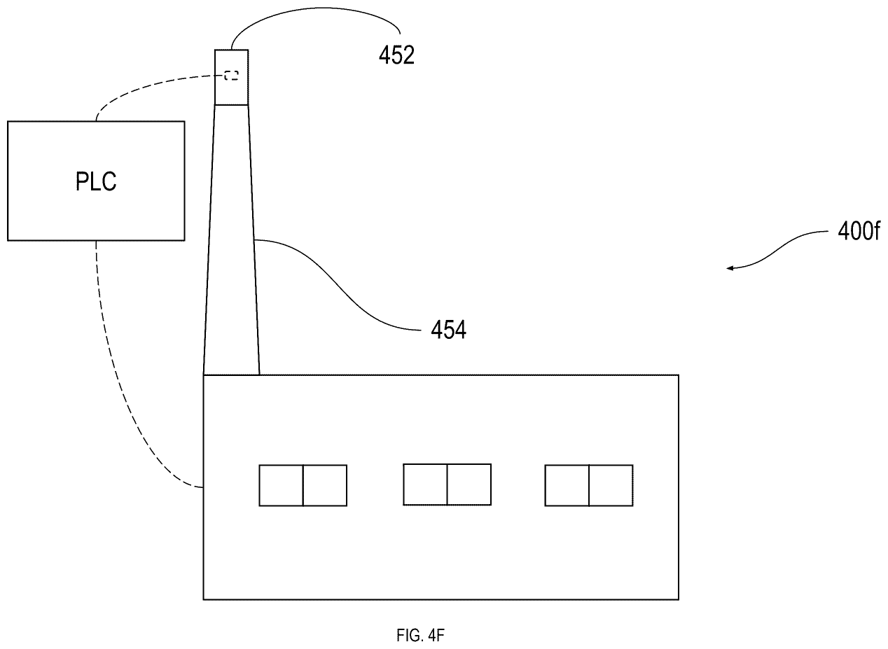

At 106, this data is provided, for example, to a device configured to access the blockchain 210. Such a device can include a consumer device, such as a tablet or the phone 304 (FIG. 4). Alternatively or in addition, the data can be accessed by an industrial asset, for example, a PLC 308. The PLC may change operating parameters of a manufacturing device in response to accessing and parsing the data. An example of such an operation is described later within this disclosure.

Using the phone 304 (or another consumer device), the blockchain is queried for the data characterizing a manufacturing process. Such a query can be performed by an application running on the consumer device. In some implementations, such a query can be initiated by scanning a code, such as a barcode or a QR code of a consumer or industrial product, with the consumer device. Such a consumer or industrial product can include a garment, a toy, an electronic device, or any other product that has had its manufacturing data stored upon the blockchain 210. Such data can include, data received from the sensor 306 characterizing species and types of VOCs detected during a manufacturing process, data characterizing lot numbers corresponding to timestamps corresponding to the manufacturing process, data characterizing a proportion of each lot directed to a subsequent step in the supply chain 200, such as a primary manufacturer 206. In some implementations, the types of VOCs include alkyl hydrocarbons, aromatic amines, amines, alkyl aldehydes, aldehydes, alkyl phenols, salicylate esters, aromatic ethers, bisphenols, phthalates, benzothiazoles, organometallics, parabens, azodyes, aceto/benzophenones, chlorinate paraffins, per-and polyfluoroalkyl substances (PFAs), halogenated hydrocarbons, aromatic hydrocarbons, ketones, alcohols, carboxylic acids, lactones, unsaturated aldehydes, and/or unsaturated ketones.

Based on this data, an amount and species of volatile organic compounds VOCs released during manufacturing of the consumer or industrial product is determined based on the received data. Such data is then provided to the consumer, for example, by displaying the amount and species of VOCs released during the manufacturing process on the phone 304. In some implementations, determining the amount and species of VOCs released during manufacturing of the consumer or industrial product is done by the phone 304. Alternatively or in addition, determining the amount and species of volatile organic compounds VOCs released during manufacturing of the consumer or industrial product is done on the blockchain, for example, by a distributed computer network.

The following descriptions and figures relating to FIGS. 4A-4F describe example manufacturing processes, devices, and/or facilities that are applicable to the subject matter described herein. For example, FIG. 4A illustrates a dryer 400a that can be used as manufacturing device 302 previously described. Plastic manufactures, compounders, molders, and/or processors use dryers to take out moisture and VOCs within incoming raw materials. In some instances, finished products are also devolatized to reduce moisture, VOC off gassing, and/or odor.

In the illustrated implementation, pellets 402 or other small particles of material, for example that can emit VOCs, such as plastic pellets, are fed into a heating chamber 404 by a material inlet 408. The material can be fed into the heating chamber 404 by an auger, gravity fed hopper, or any other motivating force without departing from this disclosure. The heating chamber 404 receives a flow of air from an air inlet 410 that is then heated by a heater 412. The air itself can be provided by an air compressor or another source of plant air. The heater 412 can include an electric heater, a heat pump, and/or a heat exchanger. Air is then directed up through the heating chamber 404 from a bottom of the heating chamber to an air outlet 414 located at a top of the heating chamber 404. The heated air pulls moisture, VOCs, and odors out of the pellets 402 and out of the air outlet 414. The air outlet 414 directs the contaminated air to the atmosphere, emitting VOCs 416 and other pollutants into the environment. Within the air outlet 414 is the sensor 306. Such a position is well suited to accurately measure the VOCs 416 emitted during manufacturing and processing. In some instances, the emitted VOCs 416 exceed a preset threshold or target. In such instances, the PLC 308 can adjust various operating parameters to reduce an amount of emitted VOCs 416. For example, the PLC 308 can lower a temperature of the heater 412, alter a feed rated of the air, or adjust the retention time of the pellets 402 within the heating chamber 404. Such an adjustment can include changing a feed rate of the material inlet 408 and/or the material outlet. Such adjustments of the dryer 400a can be used to reduce an amount of emitted VOCs 416.

While a chamber-style dryer 400a is illustrated and described, other styles of dryer can be used without departing from this disclosure. For example, tray dryers, fluidized bed dryers, or hopper dryers can be used without departing from this disclosure. In some implementations, dryers include a circulation function to mix the materials being dried or devolatized. In some implementations, a condenser or condensation tank is used to collect condensed water or volatile at the air/volatile outlet. In such implementations, the sensor 306 can be placed after the condensation tank. Such implementations are described throughout this disclosure. The subject matter described herein is applicable to both batch and continuous processing.

FIG. 4B is a schematic diagram of a blender 400b that can be used as manufacturing device 302 previously described. In some instances, plastic manufactures, compounders, molders and/or processors frequently use blenders to pre-blend components of a plastic formulate and to take out moisture and VOCs in incoming raw materials. Sometimes the finished products are also devolatized to reduce moisture, VOCs, and/or odor using the similar devices.

In the illustrated implementation, a heated chamber 420 surrounds a central mixing shaft 422. The mixing shaft 422 is driven by a variable speed electric motor (VSD 423) which is coupled to and controlled by the PLC 308. The heated chamber 420 defines a material inlet 408 and a material outlet 418. Material is received by the chamber 420 through the material inlet 408 and is mixed at a target temperature for a set duration of time. During mixing, a vacuum is pulled on the mixture by a vacuum pump 424 which is coupled to and controlled by the PLC 308. The vacuum draws out VOCs, moisture, and other pollutants from the mixture, the combination of which makes up an exhaust gas. The exhaust gas is directed towards an exhaust outlet 426. In some implementations, the vacuum is not pulled, and the exhaust gas are vented out directly through outlet 426. In the illustrated implementation, a condensing tank 428 is downstream of the vacuum pump 424; however, the vacuum pump can be located upstream of the vacuum pump without departing from this disclosure. The condensing tank 428 allows at least some of the moisture, VOCs, and/or other pollutants to drop out of the exhaust gas. In some implementations, the condensed liquid is directed to a waste treatment system for further processing and disposal according to the governmental rules and regulations. The condensed liquid can be converted to something less toxic, incinerated, or directed to a landfilled if the condensed becomes solid after treatment and if the regulation allows. In some implementation, components of the condensed liquid are used after treatment and purification. The sensor 306 is then located downstream of the condenser to detect and measure an amount of VOCs 416 and other pollutants released to the atmosphere. In some instances, the emitted VOCs 416 exceeds a preset threshold or target. In such instances, the PLC 308 can adjust various operating parameters to reduce an amount of emitted VOCs 416. For example, the PLC 308 can lower a temperature of the chamber 420, alter a vacuum pressure provide by the vacuum pump 424, change a speed of the VSD 423 and mixing shaft 422, or adjust the retention time of the material within the chamber 420. Such adjustments of the mixer 400c can be used to reduce an amount of emitted VOCs 416 and/or to reduce the degree of material degradation. While a horizontal mixer is primarily illustrated and described, other styles of mixers can be used without departing from this disclosure. For example, a ribbon blender, a vertical blender, a tumble blender, a plough mixers, and/or a high-speed mixer can be used.

FIG. 4C is a schematic diagram of a twin screw extruder that can be used as the manufacturing device 302 previously described. Twin screw extruders or other types of melt mixers are commonly used by polymer compounders to mix all ingredients in a formulation to produce plastic pellets. In some implementations, twin screw extruder is used to simultaneously mix and extrude finished products such as pipes, tubing, profiles, and cables.

In the illustrated example, a barrel 428 defines a material inlet 408 and an exhaust outlet 426. In some implementations, the material includes plastic melt. The barrel is heated to a preset temperature profile along the barrel. Within the barrel 428 is a combination screw and and shaft 430 arranged in a predefined configuration for mixing. The combination screw and shaft 430 is driven by the VSD 423 which is coupled to and controlled by the PLC 308. The screw and shaft 430 mixes and directs the plastic melt into a heated melt pump 432 and pelletizer 434, both coupled to and controlled by the PLC 308. In some implementations, one or more sections of the barrel is cooled to reduce the material degradation created by high melt temperature and mechanical shearing of the plastic melt by the screw and shaft 430 within the barrel. The melt pump 432 builds constant pressure for the plastic melt and provides constant flow of the plastic melt to the pelletizer 434, and the pelletizer 434 shapes the plastic melt into plastic pellets. In some embodiments, the melt is not needed, for example, when the process is stable and constant melt pressure is achieved at the end of the twin screw extruder before the pelletizer. During mixing, a vacuum is pulled on the mixture through a vacuum port attached with a vent stuffer 424 which is coupled to and controlled by the PLC 308. The purpose of the vent stuffer 424 is to prevent the overflow or blocking of the vent port by the polymer melt. The vacuum draws out VOCs, moisture, and other pollutants from the mixture, the combination of which makes up an exhaust gas. The exhaust gas is directed towards an exhaust outlet 426. In the illustrated implementation, a condensing tank 428 is downstream of the vacuum port and vent stuffer 424. The condensing tank 428 allows at least some of the moisture, VOCs, and/or other pollutants to drop out of the exhaust gas. In some implementations, the condensed liquid is directed to a waste treatment system for further processing and disposal according to the governmental rules and regulations. The condensed liquid can be converted to something less toxic, incinerated, or directed to a landfilled if the condensed becomes solid after treatment and if the regulation allows. In some implementation, components of the condensed liquid are used after treatment and purification. The sensor 306 is then located downstream of the condenser to detect and measure an amount of VOCs 416 and other pollutants released to the atmosphere. In some instances, the emitted VOCs 416 exceeds a preset threshold or target. In such instances, the PLC 308 can adjust various operating parameters to reduce the degree of material degradation inside the barrel and to reduce the amount of emitted VOCs 416. For example, the PLC 308 can lower a temperature of the barrel and lower a speed of the VSD 423 and screw and shaft 430 to reduce an amount of emitted VOCs 416.

FIG. 4D is a schematic diagram of a single screw extruder 400d that can be used as the manufacturing device 302 previously described. Extruder 400d, which includes an inlet 408 arranged to receive and direct plastic pellets to a screw 436 inside a barrel 428 which is heated, for example, by electricity or heating oil. In some implementations, the barrel 428 includes cooling to control the temperature fluctuation. The screw 436 is driven by the VSD 423 which is coupled to and controlled by the PLC 308. The barrel 428 and screw 436 melt the plastic pellets to produce plastic melt, mix the plastic melt and convey the plastic melt into a temperature controlled extrusion die 438 coupled to and controlled by the PLC 308. The extrusion die 438 shapes the plastic melt into a single plastic strand 440. This plastic strand 440 can be spooled onto a spool 42 for shipment and storage. During operation, pollutants, such as VOCs 416 are emitted. These VOCs 416 are drawn into a vent hood 444 and directed towards the sensor 306, which then produces a signal indicative of, or data characterizing, amounts of various species of VOCs 416 emitted during manufacturing. The vent hood 444, in some implementations, is placed near a point of high sheer in the manufacturing process as such locations can often produce a greater amount of VOCs. The PLC 308 is then able to combine this data from the sensor 306 with data characterizing lot numbers corresponding to timestamps corresponding to the manufacturing process. In some instances, the emitted VOCs exceeds a preset threshold or target. In such instances, the PLC 308 can adjust various operating parameters to reduce an amount of emitter VOCs. For example, the PLC 308 can lower a temperature of the extruder barrel 428 and/or lower a speed of the VSD 423 and screw 436 to reduce material degradation and an amount of emitted VOCs 416.

FIG. 4E is a schematic diagram of an injection mold system 400e that can be used as the manufacturing device 302 previously described. Injection molding involve directing a plastic melt through runners 446 and into mold cavity 448 where the plastic melt is solidified. During this process, the system vents air and VOCs in the plastic melt and in a runner (conduit) 446 and mold cavitie 448 out through vents 450. These vents are sized to ensure a large enough pressure drop through the vent to ensure that mostly gas is vented, and very little (if any) plastic melt is vented out. Within such vents the sensor 306 can be placed to allow for VOC detection. In some instances, the emitted VOCs exceeds a preset threshold or target. In such instances, the PLC 308 can adjust various operating parameters to reduce an amount of emitter VOCs. For example, the PLC 308 can lower a temperature of the plastic melt.

FIG. 4F is a schematic diagram of manufacturing facility 400f that can be used as any of the suppliers 202, refiners 204, or primary manufactures 206 previously described. In some implementations, multiple vents/exhausts of manufacturing devices 302 within the manufacturing facility can be tied to a common header. Such a common header can define a common exhaust outlet 452, for example, at an upper end of a stack 454. In some implementations, the sensor 306 can be placed near such an outlet 452 to get a final reading on the total VOC emissions produced by the manufacturing facility 400f. In some implementations, the sensor 306 can be used to trouble shoot other sensors within the facility as the total VOCs detected across multiple devices can equal the total VOCs detected at the header outlet 452.

The subject matter described herein is applicable to several different industries and/or products produced and/or manufacturing sites, for example, in the manufacturing or use of paints, paint strippers, solvents, wood preservatives, aerosol sprays, cleansers, disinfectants, moth repellents, air fresheners, fuels, automotive products, coatings, dry-cleaning products, pesticides, plastics, packaging, textiles, consumer or industrial products, building materials and furnishings, office equipment, correction fluids, copy paper, graphic and craft materials, glues and adhesives, permanent markers, and photographic development fluids.

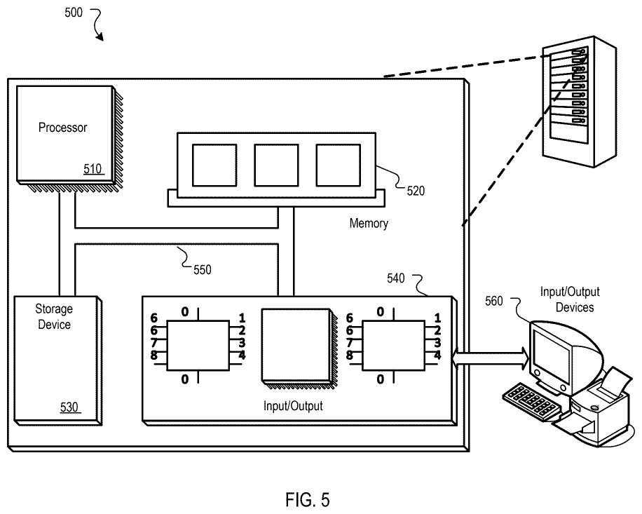

FIG. 5 is a block diagram of an example computer system 500. For example, referring to FIG. 3, PLC 308 could be an example of the system 500 described here, as could a computer system used by any of the users who access resources of PLC 308, blockchain 210, or the consumer device 304 as shown in FIG. 3. The system 500 includes a processor 510, a memory 520, a storage device 530, and one or more input/output interface devices 540. Each of the components 510, 520, 530, and 540 can be interconnected, for example, using a system bus 550.

The processor 510 is capable of processing instructions for execution within the system 500. The term “execution” as used here refers to a technique in which program code causes a processor to carry out one or more processor instructions. In some implementations, the processor 510 is a single-threaded processor. In some implementations, the processor 510 is a multi-threaded processor. In some implementations, the processor 510 is a quantum computer. The processor 510 is capable of processing instructions stored in the memory 520 or on the storage device 530. The processor 510 may execute operations such as exchanging and storing data between the PLC 308, blockchain 210, and/or the consumer device 304.

The memory 520 stores information within the system 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 can include, for example, a hard disk device, an optical disk device, a solid-state drive, a flash drive, magnetic tape, or some other large capacity storage device. In some implementations, the storage device 530 may be a cloud storage device, e.g., a logical storage device including one or more physical storage devices distributed on a network and accessed using a network. In some examples, the storage device may store long-term data, such as data characterizing a manufacturing process. The input/output interface devices 540 provide input/output operations for the system 500. In some implementations, the input/output interface devices 540 can include one or more of a network interface devices, e.g., an Ethernet interface, a serial communication device, e.g., an RS-232 interface, and/or a wireless interface device, e.g., an 802.11 interface, a 3G wireless modem, a 4G wireless modem, etc. A network interface device allows the system 500 to communicate, for example, transmit and receive data such as a total amount and species of VOC produced during the manufacture of a consumer or industrial product as shown in FIG. 4, e.g., using the blockchain shown in FIG. 3. In some implementations, the input/output device can include driver devices configured to receive input data and send output data to other input/output devices, e.g., keyboard, printer and display devices 560. In some implementations, mobile computing devices, mobile communication devices, and other devices can be used.

Referring to FIG. 3, computer program modules/software can be realized by instructions that upon execution cause one or more processing devices to carry out the processes and functions described above, for example, recording, storing, and/or exchanging data characterizing a manufacturing process. Such instructions can include, for example, interpreted instructions such as script instructions, or executable code, or other instructions stored in a computer readable medium.

A cloud or block chain, as shown in FIG. 3 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 500 is contained within a single integrated circuit package. A system 500 of this kind, in which both a processor 510 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 540.

Although an example processing system has been described in FIG. 5, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server (e.g., the cloud or blockchain as shown in FIG. 3) is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Unless otherwise defined, all terms of art, notations and other scientific terms or terminology used herein are intended to have the meanings commonly understood by those of skill in the art to which this disclosure pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

The singular form “a”, “an”, and “the” include plural references unless the context clearly dictates otherwise. For example, the term “a cell” includes one or more cells, including mixtures thereof. “A and/or B” is used herein to include all of the following alternatives: “A”, “B”, “A or B”, and “A and B”.

It is understood that aspects and implementations of the disclosure described herein include “comprising”, “consisting”, and “consisting essentially of” aspects and implementations.

As used herein, “comprising” is synonymous with “including”, “containing”, or “characterized by”, and is inclusive or open-ended and does not exclude additional, unrecited elements or method steps. Any recitation herein of the term “comprising”, particularly in a description of components of a composition or in a description of steps of a method, is understood to encompass those compositions and methods consisting essentially of and consisting of the recited components or steps. As used herein, “consisting of” excludes any elements, steps, or ingredients not specified in the claimed composition or method. As used herein, “consisting essentially of” does not exclude materials or steps that do not materially affect the basic and novel characteristics of the claimed composition or method.

Where a range of values is provided, it is understood by one having ordinary skill in the art that all ranges disclosed herein encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as dis-cussed above. As will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number. If the degree of approximation is not otherwise clear from the context, “about” means either within plus or minus 10% of the provided value, or rounded to the nearest significant figure, in all cases inclusive of the provided value.

It is appreciated that certain features of the disclosure, which are, for clarity, described in the context of separate implementations, may also be provided in combination in a single implementation. Conversely, various features of the disclosure, which are, for brevity, described in the context of a single implementation, may also be provided separately or in any suitable sub-combination. All combinations of the implementations pertaining to the disclosure are specifically embraced by the present disclosure and are disclosed herein just as if each and every combination was individually and explicitly disclosed. In addition, all sub-combinations of the various implementations and elements thereof are also specifically embraced by the present disclosure and are disclosed herein just as if each and every such sub-combination was individually and explicitly disclosed herein.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

While this disclosure contains many specific embodiment details, these should not be construed as limitations on the scope of what may be claimed, but rather as descriptions of features specific to particular embodiments. Certain features that are described in this disclosure in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

Other embodiments can be within the scope of the following claims.

What is claimed is:

1. A method comprising:
receiving data characterizing a manufacturing process;
determining an amount and species of volatile organic compounds (VOCs) released during manufacturing based on the data characterizing the manufacturing process; and
providing the data characterizing the amount and species of VOCs released during the manufacturing process.

2. The method of claim 1, wherein the data characterizing the manufacturing process comprises:
data received from a sensor characterizing species and types of VOCs detected during a manufacturing process; and
data characterizing lot numbers corresponding to timestamps corresponding to the manufacturing process.

3. The method of claim 1, wherein the data characterizing the manufacturing process comprises:
a proportion of each lot directed to a subsequent manufacturer.

4. The method of claim 1, wherein providing the data characterizing the amount and species of VOCs released during the manufacturing process comprises:
determining a chemical fingerprint based on the data characterizing the amount and species of VOCs released during the manufacturing;
storing the chemical fingerprint on a blockchain.

5. The method of claim 1, wherein providing the data characterizing the amount and species of VOCs released during the manufacturing process comprises:
displaying the amount and species of VOCs released during the manufacturing process on a consumer device.

6. The method of claim 1, further comprising:
adjusting operating parameters of a manufacturing device based on the determined amount and species of volatile organic compounds (VOCs) released during manufacturing.

7. A system comprising:
a manufacturing device;
a sensor coupled to the manufacturing device, the sensor configured to sense an amount and species of volatile organic compounds (VOCs) produced by the manufacturing device, the sensor configured to produce a signal indicative of the amount and species of the VOCs produced;
a controller coupled to the manufacturing device and the sensor, the controller configured to control the manufacturing device responsive to the signal; and
a cloud-based storage system coupled to the controller, the cloud-based storage system configured to receive data characterizing a manufacturing process from the controller, the data characterizing the manufacturing process including data characterizing the signal.

8. The system of claim 7, wherein the cloud-based storage system comprises functionality for storing data on a blockchain.

9. The system of claim 7, wherein the cloud-based storage system comprises functionality for generating a cryptographically secure portion of data, wherein the cryptographically secure portion of data comprises the data characterizing the manufacturing process.

10. The system of claim 7, wherein the data characterizing the manufacturing process comprises:
data received from a sensor characterizing species and types of VOCs detected during a manufacturing process; and
data characterizing lot numbers corresponding to timestamps corresponding to the manufacturing process.

11. The system of claim 7, wherein the data characterizing the manufacturing process comprises:
a proportion of each lot directed to a subsequent manufacturer.

12. A method comprising:
querying a blockchain storing data characterizing a manufacturing process;
receiving data characterizing a manufacturing process responsive to querying the blockchain;
determining an amount and species of volatile organic compounds (VOCs) released during manufacturing of a consumer or industrial product based on the data characterizing the manufacturing process; and
providing the data characterizing the amount and species of VOCs released during the manufacturing process.

13. The method of claim 12, wherein the data characterizing the manufacturing process comprises:
data received from a sensor characterizing species and types of VOCs detected during a manufacturing process; and
data characterizing lot numbers corresponding to timestamps corresponding to the manufacturing process.

14. The method of claim 12, wherein the data characterizing the manufacturing process comprises:
a proportion of each lot directed to a subsequent manufacturer.

15. The method of claim 12, further comprising:
receiving, by a consumer device, data characterizing a barcode of a consumer or industrial product, wherein querying occurs in response to receiving the data characterizing the barcode.

16. The method of claim 15, wherein the product is a garment.

17. The method of claim 15, wherein providing comprises:
displaying the amount of VOCs produced during the manufacture of the consumer or industrial product.

18. The method of claim 15, wherein determining amount and species of volatile organic compounds (VOCs) released during manufacturing of the consumer or industrial product is done by a consumer device.

19. The method of claim 18, wherein the consumer device is a mobile phone or tablet.

20. The method of claim 15, wherein determining amount and species of volatile organic compounds (VOCs) released during manufacturing of the consumer or industrial product is done by a cloud-based system.

21. The method of claim 12, wherein the species of the VOCs includes a chemical composition from at least one of the following chemical groups:
alkyl hydrocarbons;
aromatic amines;
amines;
alkyl aldehydes;
aldehydes;
alkyl phenols;
salicylate esters;
aromatic ethers;
bisphenols;
phthalates;
benzothiazoles;
organometallics
parabens;
azodyes;
aceto/benzophenones;
chlorinate paraffins;
per-and polyfluoroalkyl substances (PFAs);
halogenated hydrocarbons;
aromatic hydrocarbons:
ketones;
alcohols;
carboxylic acids:
lactones;
unsaturated aldehydes; or
unsaturated ketones.
